(19) United States
(12) Patent Application Publication
(10) Pub. No.: US 2003/0043985 A1
(43) Pub. Date: Mar. 6, 2003

(54) Multimedia access terminal for providing prepaid telecommunication and remote access services

(76) Inventor: Robert Wu, Princeton Junction, NJ (US)

Correspondence Address: Allen R. Kipnes, WATOV & KIPNES, P.C., P.O. BOX 247, PRINCETON JUNCTION, NJ, 08550, US

(21) Appl. No.: 09/944,272

(22) Filed: Aug. 31, 2001

(51) Int. Cl. H04M 17/00

(52) U.S. Cl. 379/144.05; 379/143; 379/155

(57) ABSTRACT

A multimedia access terminal for providing telecommunication and remote access services to a customer, in which the multimedia access terminal comprises a microcontroller for executing preprogrammed instructions and generating directives, a payment acceptor electrically connected and responsive to the microcontroller for accepting payment from the customer to pay for access to the services, a network interface device electrically connected and responsive to the microcontroller for connecting with a central service provider server via a global communications network, and a multimedia user interface electrically connected and responsive to the microcontroller for enabling exchange of information with the customer during access to the services upon acceptance of the payment.

### FIELD OF THE INVENTION

The present invention relates generally to telecommunications systems, more particularly to a multimedia access terminal capable of providing prepaid telecommunication and remote access services to a customer.

### BACKGROUND OF THE INVENTION

As computer and telecommunications technologies continue to integrate and mature, many important applications have arisen from their development including, for example, electronic mail, computer networking, and high bandwidth data transmission. The most phenomenal growth has been in the development and growth of the global communications network or the Internet creating major changes in the ways people work and live.

Many portable electronic devices such as mobile computers, personal computers, personal digital assistants, cellular telephones and the like, have been developed or modified to provide instant access to communication applications including facsimile and telephone call transmission, email, data transfer and the like, while away from home or office. With this dependency, many have come to rely on such portable electronic devices for satisfying their communication needs during travel and commute. However, the portable electronic devices experience several limitations.

Access through such devices require costly and often unreliable network services for access to the communication applications. Such portable electronic devices can become outmoded, lost, stolen or damaged. They further require battery power for operation over a limited time. For extended use, the user would need to carry multiple battery packs especially if a power source is not available. Although the development in the area of telecommunications have made great strides in progress, access to telecommunications systems have been limited in public places to wireless means (e.g. satellite and cellular).

Accordingly, there is a need for a multimedia access terminal capable of providing telecommunications and remote access services in public locations which at least substantially relieves the limitations encounter by the user as described above. Such multimedia access terminals can provide a customer with access to data and information systems for video/text/graphics transfer and facsimile and telephone communications, and the like, in any public area including, but not limited to, airports, convention centers, bus terminals, shopping centers, restaurants, arenas, and buildings. The access terminal of the present invention provides the equipment and communication applications necessary for the customer to access the communication services. The access terminal is connected to the global communications network for low cost, reliability and extensive accessability.

### SUMMARY OF THE INVENTION

The present invention is directed generally to a multimedia access terminal for providing prepaid telecommunications and remote access services to a customer. The telecommunication and remote access services include, but not limited to, telephone and facsimile calling service, and Internet computer access service. The multimedia access terminal is operatively connected to a remote service provider gateway server through a global communications network. The gateway server provides a centralized hub from which the multimedia access terminal may link to other destinations for implementing high bandwidth data communications. Preferably, the customer may use an access terminal on a prepaid basis. A centralized authentication, authorization and accounting system is utilized in association with a prepaid card for providing reliable access control and billing procedures for the customer.

In one aspect of the present invention, there is provided a multimedia access terminal for providing prepaid telecommunication and remote access services, in which the access terminal comprises:

a microcontroller for executing preprogrammed instructions and generating directives;

a payment acceptor electrically connected and responsive to the microcontroller for accepting payment from the customer to pay for access to the services;

a network interface device electrically connected and responsive to the microcontroller for connecting the access terminal with a central service provider server via a global communications network; and

a multimedia user interface electrically connected and responsive to the microcontroller for enabling exchange of information with the customer during access to the services upon acceptance of the payment.

In another aspect of the present invention, there is provided a multimedia access terminal network for providing prepaid telecommunication services, in which the network comprises:

an access terminal comprising a multimedia user interface for enabling exchange of information between the customer and the access terminal during access to the services;

a remote service provider server connected and in operative communication with a service provider gateway server; and

a global communications network connecting the access terminal and the remote service provider server for facilitating data communication therebetween.

### BRIEF DESCRIPTION OF THE DRAWINGS

The following drawings in which like reference characters indicate like parts are illustrative of embodiments of the invention and are not to be construed as limiting the invention as encompassed by the claims forming part of the application.

FIG. 1 is a front perspective view of a multimedia access terminal for providing a customer with prepaid telecommunication and remote access services for one embodiment of the present invention;

FIG. 2 is a schematic diagram of an architecture of the multimedia access terminal in accordance with the present invention;

FIG. 3 is a schematic diagram of a multimedia access terminal network for one embodiment of the present invention;

FIG. 4 is a schematic diagram of the architecture of multimedia access terminal network of FIG. 3; and

FIG. 5 is schematic diagram of the multimedia access terminal network further including a prepaid billing component for providing telecommunication and remote access services through the multimedia access terminal in accordance with the present invention.

### DETAILED DESCRIPTION OF THE INVENTION

The present invention is directed generally to a multimedia access terminal for providing prepaid telecommunication and remote access services to a customer. The multimedia access terminal is designed to provide telecommunications service and other remote access applications in a reliable and cost efficient manner. The multimedia access terminal is connected through a global communications network to a central service provider server for enabling reliable high-speed broadband data transmission while maintaining low implementation costs and convenient accessibility. More specifically, the multimedia access terminal is equipped to provide telephone and facsimile calling service through both the global communications network and the public switched telephone network (PSTN), and provide network access service over the global communications network including the Internet. The present invention is further directed to a network configured for providing the telecommunications and remote access services through the multimedia access terminal of the present invention.

The customer using the multimedia access terminal can remotely access the global communications network such as the Internet including the World Wide Web (WWW) for web browsing and the like. The WWW is a graphical user interface system that facilitates access to information on the Internet by organizing it into pages. WWW also provides hyperlinks, which, when “clicked” with a mouse, downloads the corresponding page located at an IP address that contains the implied information. For telephone or facsimile calling service, the call transmitted over the global communications network may be routed to a IP networked telephone or facsimile-enabled computer, or to a public switched telephone networked telephone or facsimile device.

The term “remote access services or applications” refers to services for enabling a customer to get into a server or computer through the global communications network to get data, software and the like from a remote location.

In accordance with a further aspect of the present invention, the multimedia access terminal utilizes a prepaid card in connection with a prepayment system for providing the telecommunication and remote access services. Although the present invention is described in association with a prepaid card, it will be understood that other forms of payment may be used to access the services through the multimedia access terminal. Under the prepayment system, the multimedia access terminal may be accessed through the prepaid card which generally includes all the information necessary to allow a customer to draw upon a prepaid account associated with the prepaid card. More specifically, the prepaid card has associated therewith an ID number or personal identification number (PIN) and optionally a customer-selected password through which a customer may access the multimedia access terminal operated by a prepaid service provider.

For security purposes, the prepaid card may be associated with a password code selected by the customer at the time of purchase of the prepaid card or during access to the multimedia access terminal. The customer-selected password code is transmitted and stored on a central database corresponding to the PIN of the prepaid card. To access services through the multimedia access terminal, the customer provides both the PIN and the customer selected password code for identification and validation. The prepaid card is protected against use by unauthorized persons. If the customer's prepaid card is stolen or lost, a replacement prepaid card with the same PIN, may be re-issued to the rightful customer. The customer of the prepaid card may be permitted to change or modify the password code periodically through the participating vendor, vending terminal or the multimedia access terminal.

In the context of the present invention set forth herein, the prepaid account corresponds to a prepaid card useful for obtaining prepaid telephone, facsimile and Internet service access. However, it will be appreciated that the present invention is not so limited, for example, virtually any type of prepaid arrangement or prepayment system may be effected through the use of the scheme discussed herein. The system may be used to obtain prepaid goods or services of any kind through the global communications network from participating merchants and service providers. In this regard, the goods may relate to data and information which may be sold through data networks, telephone networks, or the Internet.

The prepaid card is typically a credit-card sized plastic card with identification information printed or stored thereon. The customer may purchase a prepaid card in advance from a participating vendor or a vending machine or terminal. The prepaid card includes a balance amount where charges accrued for services or goods obtained may be deducted therefrom. The balance amount entitles the customer to a specific access amount or time. For example, the balance amount may provide 30 minutes of access time for a specified dollar amount (e.g. $2.00). The prepaid card may be sold with balance amounts in multiple denominations such as $1, $5, $10, $20, and $50, or any customer selected prepayment or debit amounts. The balance amounts may subsequently be renewed by depositing additional debit amounts through the vendor or vending terminal.

A prepaid card or PIN database residing on a remote central billing server stores account information including password codes, usage history, etc., correlated to each prepaid card sold or distributed. The remote central billing server is accessible through the global communications network which enables the vendors and vending terminals to communicate with the remote central billing server to update the PIN database when additional prepayment or debit amounts have been deposited to a prepaid card. Under this prepayment system, the prepaid card customer is permitted access to the multimedia access terminal upon appropriating authorization and clearance from the remote central billing server as will be described hereinafter.

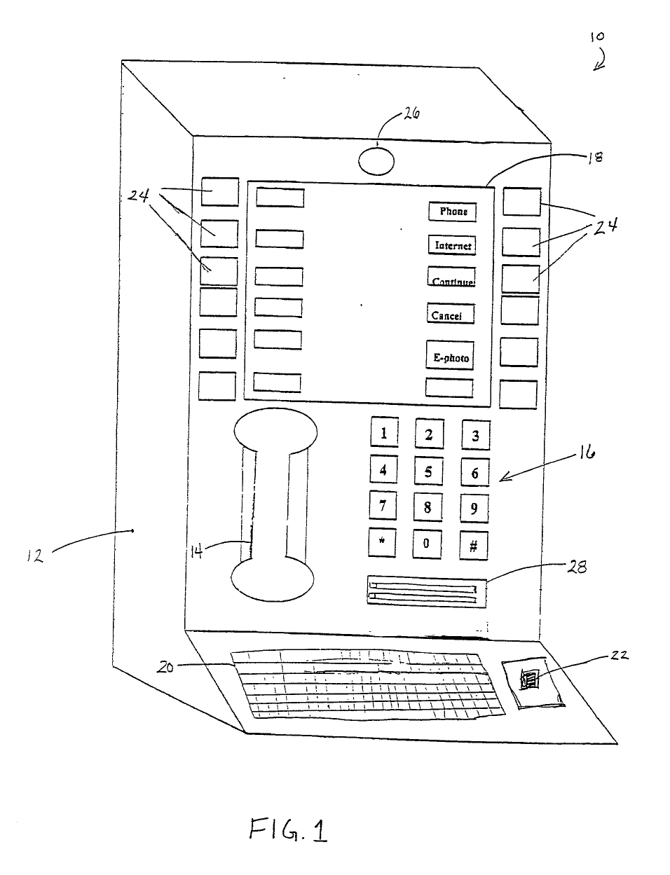

Referring to FIG. 1, an multimedia access terminal 10 is shown for one embodiment of the present invention. The multimedia access terminal 10 includes a housing 12 for securing and accommodating the component parts into a single unit. The multimedia access terminal 10 is capable of providing high speed Internet computer access and telephone and facsimile calling service from a publicly accessible location. The multimedia access terminal 10 includes any suitable input and output devices for facilitating a multimedia interface with the customer. The term “multimedia interface” refers to the point of interaction or communications through combined use of one or more media formats between the computer terminal and the customer. Such media formats may include text, graphics, animation, audio, video and the like. The multimedia access terminal 10 may be placed at any location that is publicly accessible such as in convenience stores, malls, restaurants and the like.

The multimedia access terminal 10 includes a microcontroller (not shown) and a telephone 13 comprising a single-line telephone handset 14 having a speaker (not shown) and a microphone (not shown), a switch-hook (not shown), a dialing circuit (not shown), a hybrid coil (not shown), and a single-line push-button dial pad 16. The multimedia access terminal 10 further includes a monitor 18 such as a 15-inch liquid crystal display unit, a user input device including a keyboard 20, a mouse pointing device 22, and a plurality of function keys 24, a universal serial bus compatible camera device 26, and a card reader 28 (e.g., magnetic strip reader).

In addition, the multimedia access terminal 10 further includes a network interface device (not shown) for connecting to a global communications network preferably through a communications channel such as such as ethernet networks, frame relay networks, synchronous optical network (SONET), asynchronous transfer mode (ATM) networks, digital subscriber loop (XDSL) networks, cable networks, satellite link, T1/T3/E1 trunk lines, integrated services digital network (ISDN), and the like for data transfer through a global communications network (i.e., the Internet). In a preferred form of the invention, the multimedia access terminal 10 connects to, and communicates with a remote central server directly over a dedicated communications channel such as through a broadband connection carrier system for enabling continuous high speed data connection. The remote central server provides a gateway through which all the multimedia access terminals of the present invention become available to the customer.

The multimedia access terminal 10 further includes a memory storage device such as a hard disk drive. The microcontroller (not shown) comprises a microprocessor, read only memory, random access memory, and other features such as a clock, interrupt control, control logic, power, and connections. The microcontroller is electronically connected via a bus to the network interface device (not shown), the telephone 14, the monitor 18, the user input devices including the keyboard 20, the mouse pointing device 22, and the plurality of function keys 24, the universal serial bus compatible camera device 26, and the card reader 28. Additionally, the microcontroller is connected via a bus to a memory device which has stored therein all of the programs required for operation of the multimedia access terminal 10.

The microprocessor is any suitable central processing unit for executing commands and controlling the multimedia access terminal 10. The random access memory serves as storage for calculated results, and as stack memory. The read only memory may be configured to store the operating system, fixed data, standard routines, look up tables and the like.

The multimedia access terminal 10 allows customers to make a telephone call to any destination PSTN line or to browse the Internet on a per-minute service charge rate. The multimedia access terminal 10 can also provide facsimile transmission service for transmitting a document to any public switched telephone network (PSTN) destination number. To facsimile a document, the customer selects an electronic document and initiates a telephone call through the multimedia access terminal 10. The telephone call is connected through the Internet and the PSTN to a destination facsimile device at the destination number for effecting transmission.

The monitor 18 is adapted to display appropriate customer prompts, additional instructions and advertising information. The plurality of function keys 24 are provided to permit the customer to input information to select the access services provided by the multimedia access terminal 10 as will be described hereinafter.

The card reader 28 is a conventionally known structure and the function in connection with the present invention will be described herein. The card reader 28 is adapted to read indicia imprinted or stored on a card. It is understood that the card reader 28 may be adapted to utilize any known card reading techniques including, but not limited to, optical, magnetic, mechanical or electronic means. For example, the prepaid card may typically include a magnetic strip, an integrated chip, or a bar code which can be read by the appropriate reader device to ascertain the information such as a PIN contained on the prepaid card.

The camera device 26 allows customers to have photographs taken of themselves for transmission via the Internet on a per-photo service charge basis. The camera device 26 may also be used in video-capable telephone calls for providing video and audio communication between two or more people in a video conference call, for example. The multimedia access terminal 10 may also be used to display advertising information on the monitor 18. Optionally, the multimedia access terminal 10 may be adapted to allow a customer to play computer games alone or with another remotely located customer on a per-minute or per-game service charge basis.

The customer may initiate access to the multimedia access terminal 10 by swiping the prepaid card into the card reader 28. The card reader 28 reads the PIN of the prepaid card. The customer is further prompted to input the customer selected password code. The PIN and password code is transmitted to an authentication server. The authentication server accesses the PIN database to review the information inputted. Upon authentication and sufficient balance amount, the authentication server provides authorization for access to the services. The authentication server retrieves the change rate from a schedule stored on the PIN database and monitors the access time of the customer. Although the present invention is described in association with a prepaid card, it is understood that the customer may access the multimedia access terminal 10 using other forms of payment including a credit card, a debit card, a check card, or the like for generating a prepayment or debit amount to create a balance amount. The payment may be drawn from the corresponding credit card, check card or debit card using conventionally known methods.

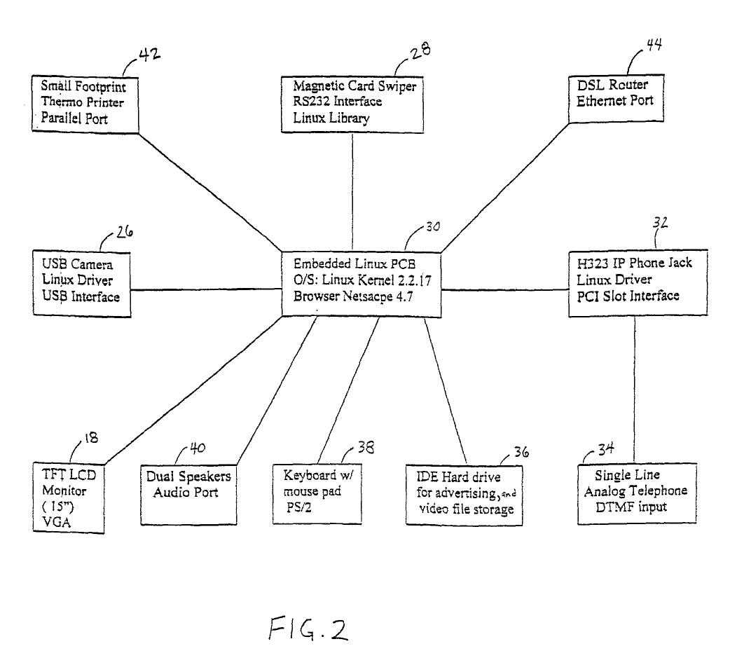

Referring to FIG. 2, an architecture of the multimedia access terminal 10 is shown. The microcontroller comprises an embedded hardware main board 30 for processing data and controlling the peripheral devices of the multimedia access terminal 10. The main board 30 includes an embedded Linux compatible printed circuit board, a 32-megabyte flash memory unit for storing an operating system such as Linux Kernel 2.2.17, a browser software program such as Netscape 4.7, and specialized software programs for executing telephony communications, Internet computer access and networking, camera operation and the like. The embedded main board is further adapted to interface with a peripheral component interconnect board such as a H323 VoIP card adapted for processing “voice over Internet” applications. The VoIP card processes and transmits voice conversations over a data network using the Internet Protocol by converting an analog voice signal into digital data packets. The VoIP card is connected to a single line analog telephone unit 34 comprising the single line telephone handset 14, and the single-line push-button dial pad 16 for initiating and placing a voice or fax telephone call.

Other peripheral components include a hard drive memory device 36 such as a 20-gigabyte integrated drive electronics hard disk, an input device 38 including the keyboard 20 and the pointing device 22, an audio output unit 40 for outputting audio information, the monitor 18, the camera device 26, a printer device 42, the card reader 28, and a network interface device 44 such as a router for connection with a network such as a digital subscriber line.

The hard drive memory device 36 may be used to store software programs associated with the operation of the camera 26, advertising information for display on the monitor 18, and backup information stored in the flash memory unit of the main board 30. The input device 38 allows the customer to input selections, information, data and the like, for using the services offered through the multimedia access terminal 10 such as composing email messages, web browsing and the like, as will be described hereinafter. The camera 26 may be used to record still or video images of the customer for transmission over the global communications network or storage in the hard drive memory device 36.

The card reader 28 generally includes a magnetic strip reader-which is interfaced with the main board 30 through an RS232 interface device, for example. The magnetic strip reader is configured to read information stored on a strip of magnetic material, usually tape, attached to a card. Information relating to the customer such as a PIN may be stored or printed thereon and subsequently read when passed through the card reader 28 for purposes of identification and retrieval of the balance amount remaining on the prepaid card. The network interface device 44 such as a DSL router is interfaced with the main board 30 through an Ethernet port.

The software utilized by the main board 30 for operating the multimedia access terminal 10 may include the Linux Kernel 2.2.17 operating system, the Netscape 4.7 web browser software, a Linux driver for running the card reader 28, a Linux driver for running the camera 26 and any additional application software for operating all the feature of the multimedia access terminal 10 which is written in a programming language such as C++.

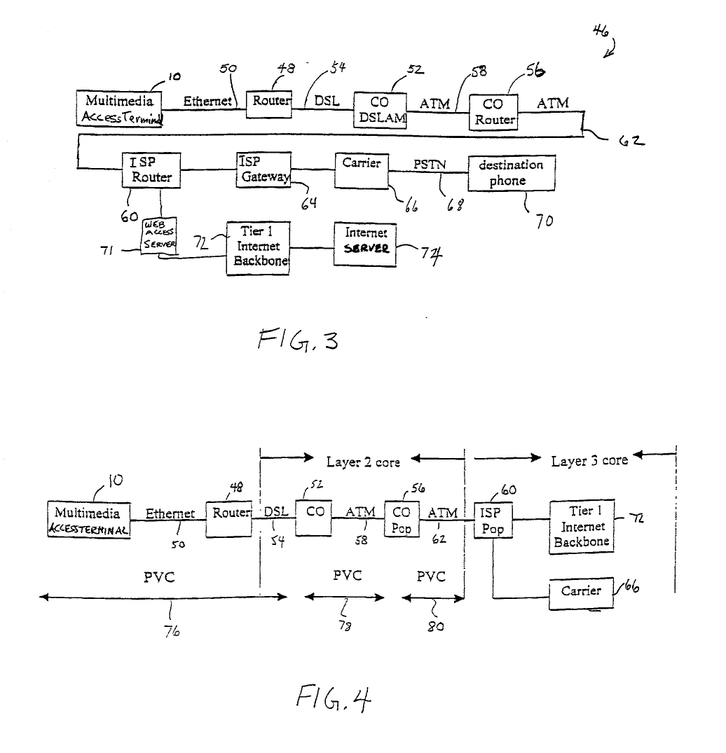

Referring to FIG. 3, a multimedia access terminal network 46 is shown for one embodiment of the present invention. The multimedia access terminal 10 is connected to a digital subscriber line router 48 through an Ethernet connection 50. The router 48 directs communications traffic between the multimedia access terminal 10 and a DSL Access Multiplexer (DSLAM) 52 at a local central office via a digital subscriber line (DSL) 54, a broadband communications channel. The DSLAM 52 is a distribution device for implementing DSL service from the central office. The DSLAM 52 combines and separates the different formats of communications (i.e., voice, video, data) contained in the DSL carrier and routes them to respective hosts.

The communications traffic is then relayed to a central office router 56 via a private virtual circuit comprising an asynchronous transfer mode channel 58. The private virtual circuit is a dedicated (private line) channel forming a part of the multiplexed transmission or packet network. The central office router 56 forwards the communications traffic from one network to another, based on address information. The central office router 56 forwards the communications traffic to an Internet Service Provider router 60 over a private virtual circuit comprising an asynchronous transfer mode channel 62. The router 60 determines whether the destination of the communications traffic is to a public switched telephone network (PSTN) 68 or to a specific server on the Internet. For telephone calls, the router 60 sends the call which is in the form of a series of voice packets to a corresponding gateway server 64. The gateway server 64 converts the voice packets to the analog signal and sends it to a carrier 66. The carrier 66 directs and transmits the signal to a destination telephone 70 via the PSTN 68.

For access to the Internet, the router 60 transmits a request to a web access server 71. The web access server 71 then routes it to a POP router (not shown) to a router 72 on a Tier 1 Internet backbone. The router 72 sends the request to a destination server 74 on the Internet. For communications traffic transmission back to the multimedia access terminal 10, the traffic follows the above-described path in reverse order.

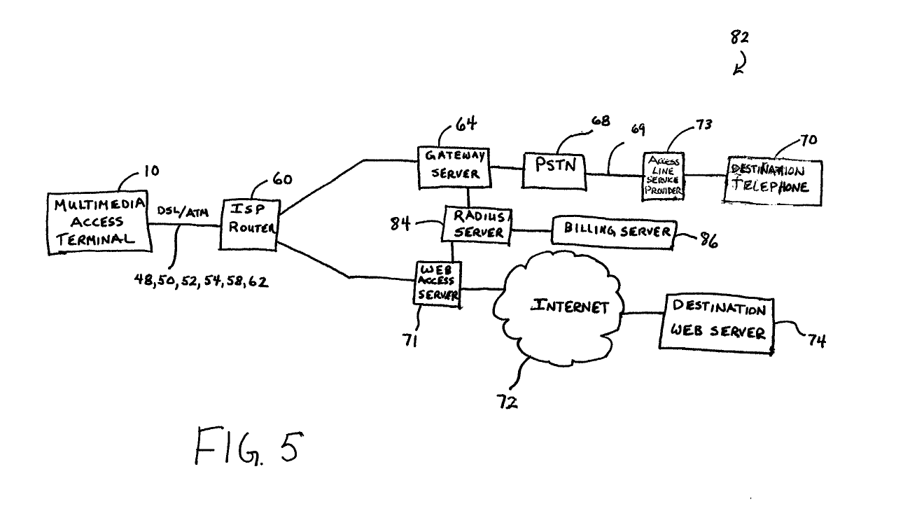

Referring to FIG. 4, the multimedia access terminal network 46 is shown with various layer cores and private virtual circuits indicated with respect to the components thereof. As shown specifically in FIG. 4, the multimedia access terminal 10 is connected to the central office 52 via the DSL channel 54, a first private virtual circuit 76, to the central office router 56 via the ATM channel 58, a second private virtual circuit 78, and to the ISP router 60 via the ATM channel 62, a third private virtual circuit 80. Therefore, each multimedia access terminal 10 is connected directly via a DSL or ATM channel to the ISP on a private virtual circuit basis for dedicated service. Each multimedia access terminal 10 is connected from the ISP to the Internet 74 or ISP gateway server 64 (see FIG. 3) on a Point to Point Protocol (PPP) status. All voice packets are sent over channels using Asynchronous Transfer Mode technology which utilizes frame-format communications protocol whereby data is transmitted and received, for example, fifty-three bytes or octets at a time. For example, there are forty-eight customer bytes for the payload and five bytes for control and addressing. The ATM channel is capable of carrying delay-sensitive transmissions without delay such as speech, music or video, and many ATM channels can be concatenated to deliver more bandwidth or carrying capacity, thus telephone calls are transmitted with good quality of service.

Referring to FIG. 5, a multimedia access terminal network 86 including a prepaid account and billing component for implementing prepaid access is shown. The communication traffic from the multimedia access terminal 10 to the ISP router 60 is transmitted in the same manner as described above in FIG. 3. The ISP router 60 identifies the destination of the communication traffic depending on the remote access application or service selected by the customer. It is noted that the network 86 is not limited to the configuration described herein and may include other configurations for facilitating a centralized access control and billing via a global communications network (i.e., the Internet) during the delivery of the prepaid telecommunications and remote access services.

The network 82 includes the components of the network 46 of FIG. 3 and further includes a central billing server 86 with a PIN database residing thereon and a remote authentication dial-in user service (RADIUS) server 84 connected to the gateway server 84 and the web access server 71, and an access line service provider 73 in connection with the gateway server 64 through the PSTN 68. The central billing server 86 maintains and updates information stored in the PIN database, including account data, user profiles, customer-selected password codes, prepaid card usage history, schedule of charge rates for the services such as domestic and international call rates, Internet computer access charge rates, and the like. The schedule of charge rates is periodically updated by the service provider.

The RADIUS server 84 is a client/server-based authentication software system that is used by service providers for implementing remote access applications and maintaining user profiles in the PIN database residing on the central billing server 86. The RADIUS server 84 can be shared by multiple multimedia access terminals 10. The RADIUS server 84 is programmed to execute authentication, authorization, and accounting procedures for checking and validating information provided by the customer desiring to access the services. This process is carried out by the RADIUS server 84 for all remote access applications and services including telephone and facsimile calling, and Internet computer access.

The central billing server 86, the RADIUS server 84 and an assigned RADIUS client which may be selected from the gateway server 64, the web access server 71, or the multimedia access terminal 10, in combination, perform the accounting, monitoring and maintenance of the services provided to the customer. The charges incurred by the customer is monitored and tracked by the RADIUS server 84 through the assigned RADIUS client. The resulting charges for usage are deducted from the balance amount according to the prevailing charge rate and the services selected. The updated balance amount is subsequently recorded by the central billing server 86 on the PIN database as will be described herein.

Upon initiating the access terminal 10, the RADIUS server 84 receives an access request from the RADIUS client (i.e. the gateway server 64 or the web access server 71) for authentication and authorization. The access request includes the PIN of the prepaid card and the customer selected password code previously furnished by the customer during initiation of the terminal 10. The information is authenticated and validated by the RADIUS server 84 through the PIN database residing on the central billing server 86. The RADIUS server 84 then reviews the balance amount on the prepaid card through the PIN database. Upon verification and review of the PIN/password code, and balance amount, the RADIUS server 84 retrieves the corresponding charge rate from the billing schedule stored on the PIN database. The RADIUS server 84 transmits an authorization message including the account information, balance amount, and charge rate to the RADIUS client (i.e. the gateway server 64 or the web access server 71). The RADIUS client implements the requested service to the customer and tracks the usage time and access charges associated therewith. Upon access, the customer may input the desired destination information such as the destination telephone number or the destination I P address to complete the connection.

At the end of the access session, the RADIUS client generates a billing report containing the usage time and history for transmission to the RADIUS server 84. The RADIUS server 84 withdraws the access authorization to the RADIUS client and forwards the billing report to the central billing server 86. The central billing server 86 receives the report and deducts the charges from the balance amount. The balance amount on the PIN database is updated to reflect the charges on the billing report. A confirmation is returned to the multimedia access terminal for display to the customer.

For access other than through a prepaid card, the charges owed are correspondingly deducted from the balance amount previously obtained through the debit card, credit card, check card, or savings/checking account, or the like, that was provided in lieu of a prepaid card. The central billing server 84 may be configured to implement electronic fund transfer transactions through the appropriate channels. In the event that the balance amount is depleted, the RADIUS server 84 immediately terminates access through the gateway server 64 and/or the web access server 71.

During the course of customer access, the RADIUS server 84 tracks and monitors the usage time and the access charges and continuously reviews the balance amount remaining through the RADIUS client. If the balance amount on the prepaid card is low, the customer is informed of the low balance amount along with the estimated time remaining. The customer may choose to replenish the prepaid card at a participating prepaid card vendor or vending terminal. The connections through the RADIUS client is terminated when the balance amount reaches zero. The vendor or vending terminal is adapted to communicate with the RADIUS server 84 to direct the central billing server 86 to update the balance amount on the prepaid card upon receipt of payment from the customer.

For telephone call service, the RADIUS server 84 transmits the authorization message with the account information and the call charge rate to the gateway server 64. The communication traffic is transmitted from the ISP router 60 to the gateway server 64 where it is converted into a form suitable for transmission through the PSTN 68. The communication traffic is transmitted through the PSTN 68 to a dedicated toll-free access line 69 (e.g. 800, 877, 888, 866 prefix PSTN lines) which may be leased or rented by the access terminal service provider from an access line provider 73. The communication traffic is transmitted from the gateway server 64 to the PSTN 68 in the same manner described above. In the present configuration, the destination telephone line number is preset and preprogrammed by the service provider into the gateway server 64 to provide automatic connection with the toll-free access line 69 each time a telephone access service is requested. The service provider of the multimedia access terminal 10 is typically charged a flat monthly rate for the access line 69, and the customer is correspondingly charged by the service provider on a per minute basis, for example.

Following connection to the access line 69, the remaining call operation is carried out by the access line provider 73. The customer may call any desired PSTN destination number through the toll-free access line 69. Upon connection, the customer is prompted by the access line provider 73 to enter the desired destination PSTN number for voice, facsimile or data transmission using the single-line push-button dial pad 16. If the customer dials a wrong destination PSTN number while connected to the toll-free access line 69, the customer can press one of the function keys 24 to reset the access line system 73 and enter another destination PSTN number. When the customer concludes a telephone call, the customer can press one of the function keys 24 to place a new telephone call without being disconnected from the access line 69. When the customer chooses to terminate the telephone service access, the gateway server 64 closes the connection and hangs up the access line 69.

As the call proceeds, the gateway server 64 monitors the connection and tracks the time duration of the connection until the call is terminated by the parties. In the event, the balance amount reaches zero, the gateway server 64 immediately terminates the call. At the conclusion of the telephone call, the gateway server 64 sends the billing report or a call detail record (CDR) to the RADIUS server 84. The call detail record contains detailed information on telephone calls connected through the gateway server 64 and typically includes number dialed and duration of each call. Each call event (transfer, connect, disconnect, etc.) gets a time stamp. The RADIUS server 84 withdraws the access authorization for the customer. The CDR is forwarded from the RADIUS server 84 to the central billing server 86 where the balance amount is updated on the PIN database.

In an alternative embodiment, the multimedia access terminal 10 may be configured to operate as a RADIUS client to the RADIUS server 84. During initiation, the multimedia access terminal 10 sends an access request for authentication, authorization, and accounting directly to the RADIUS server 84. The RADIUS server 84 carries out the authentication procedure described above, assigns a dynamic IP address to the multimedia access terminal 10, and reviews the balance amount on the prepaid card and the call charge rate through the PIN database residing on the central billing server 86. The RADIUS server 84 transmits an authorization message to the multimedia access terminal 10 where the call is arranged by the gateway server 64. The gateway server 64 connects the call to the destination telephone 70 as described above. When the call is connected, the multimedia access terminal 10 monitors and tracks the time duration of the call. Upon conclusion of the call, the multimedia access terminal 10 generates and transmits a CDR to the RADIUS server 84. The CDR is forwarded to the central billing server 86 for update of the balance amount. The multimedia access terminal 10 can terminate the call when the balance amount reaches zero. The CDR is generated and transmitted to the RADIUS server 84 for updating the account information of the prepaid card.

For remote access service, the authentication and validation procedures are executed through the web access server 71, a RADIUS client. The RADIUS server 84 authenticates the PIN and the password code and reviews the balance amount on the prepaid card and the access charge rate. The RADIUS server 84 transmits an authorization message to the web access server 71 where the access is provided. The customer is permitted access to the Internet through the web access server 71. The web access server 71 directs the communications traffic to the global communications network 72 (i.e. the Internet). The communication traffic with the corresponding IP address is routed through the global network 72 to the destination web server 74. The web access server 71 monitors and tracks the time duration of the Internet computer access. When the Internet computer access is terminated, the web access server 71 generates a Browsing Detail Record (BDR) which contains the details of the customer's access session such as time duration and browsing history. The BDR is forwarded from the web access server 71 to the RADIUS server 84. The RADIUS server 84 withdraws the access authorization and forwards the central billing server 86 for updating the balance amount on the PIN database. The web access server 71 terminates the connection when the balance amount on the prepaid card reaches zero, and transmits the BDR to the RADIUS server 84.

In an alternative embodiment, the multimedia access terminal 10 may be configured to operate as a RADIUS client to the RADIUS server 84. During initiation, the multimedia access terminal 10 sends an access request for authentication, authorization, and accounting directly to the RADIUS server 84. The RADIUS server 84 carries out the authentication procedure described above, assigns a dynamic IP address to the multimedia access terminal 10, and reviews the balance amount on the prepaid card and the call charge rate through the PIN database residing on the central billing server 86. The RADIUS server 84 transmits an authorization message to the multimedia access terminal 10 where the call is arranged by the web access server 71. The access session is implemented in the same manner described above, however, the RADIUS client is the multimedia access terminal 10.

The multimedia access terminal 10 is capable of handling several services simultaneously (e.g. telephone call and Internet computer access). The multimedia access terminal 10 is programmed to operated as a RADIUS client to the RADIUS server 86 for direct communication between the RADIUS server 84 and the multimedia access terminal 10. The accounting process is carried out in the same manner as described above, however, the multimedia access terminal monitors the duration of both the telephone call and the Internet computer access simultaneously. Typically, the two respective service charge rates are summed for the combined service usage. For example, a customer may place a call to Mexico for an international call rate of 12 cents a minute, and access the Internet at a usage rate of 7 cents per minute, the multimedia access terminal 10 tracks the total service charge rate of 19 cents per minute during the dual session. Upon conclusion of the telephone call and Internet computer access services, the CDR and the BDR are respectively generated by the multimedia access terminal 10 and transmitted to the RADIUS server 84 for forwarding to the central billing server 86. If one service is terminated and the other service remain active, the multimedia access terminal 10 continues monitoring and tracking of the active service.

During periods of inactivity, advertising for other services, or for goods or services of third-parties can be displayed on the monitor 18 to pedestrians and passer-bys. The advertising material is typically stored on the local memory storage device (e.g. hard drive) and retrieved by the microcontroller for periodic display on the monitor 18.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A multimedia access terminal for providing telecommunication and remote access services to a customer, the multimedia access terminal comprising:
a microcontroller for executing preprogrammed instructions and generating directives;
a payment acceptor electrically connected and responsive to said microcontroller for accepting payment from the customer to pay for access to the services;
a network interface device electrically connected and responsive to the microcontroller for connecting with a central service provider server via a global communications network; and
a multimedia user interface electrically connected and responsive to said microcontroller for enabling exchange of information with the customer during access to the services upon acceptance of said payment.

2. The multimedia access terminal of claim 1 further comprising:
a telephone electrically connected and responsive to the microcontroller for enabling the customer to exchange a telephone conversation with a destination telephone connected to the central service provider.

3. The multimedia access terminal of claim 2 wherein the telephone comprises a dialing circuit, a switch-hook, a hybrid coil, and a handset with a microphone and a speaker.

4. The multimedia access terminal of claim 1 wherein the central service provider server is connected to a gateway server adapted for data flow point of entry from the global communications network into a public switched telephone network.

5. The multimedia access terminal of claim 1 wherein the multimedia user interface further comprises:
input means for enabling a customer to input information including access to and selection of services; and
output means for conveying information and prompts from the multimedia access terminal to the customer.

6. The multimedia access terminal of claim 5 wherein the input means is selected from the group consisting of push-button dial pads, alphanumeric keyboards, alphanumeric key pads, mouse pointing devices, function key pads, touch screens, cursor tracking devices, camera devices, card readers, and microphones.

7. The multimedia access terminal of claim 2 wherein the output means is selected from the group consisting of displays, printers, and speakers.

8. The multimedia access terminal of claim 1 wherein the network interface device is interfaces with the global communications network through a communications channel selected from the group consisting of ethernet networks, frame relay networks, synchronous optical network (SONET), asynchronous transfer mode (ATM) networks, digital subscriber loop (XDSL) networks, cable networks, satellite link, T1/T3/E1 trunk lines, integrated services digital network (ISDN), and combinations thereof.

9. The multimedia access terminal of claim 1 further comprising a camera for taking images of the customer.

10. The multimedia access terminal of claim 1 further comprising a memory means for storing advertising information for exhibition through the multimedia user interface.

11. The multimedia access terminal of claim 1 wherein the payment acceptor is a card reader adapted for reading indicia related to a prepaid balance amount on a prepaid card.

12. A multimedia access terminal network maintained by a service provider for furnishing telecommunication and remote access services to a customer, said network comprising:
an multimedia access terminal comprising a multimedia user interface for enabling exchange of information between the customer and the multimedia access terminal during access to said services;
a remote service provider server connected and in operative communication with a service provider gateway server; and
a global communications network connecting the multimedia access terminal and the remote service provider server for facilitating data communication therebetween.

13. The multimedia access terminal network of claim 12 wherein the service provider server is connected to a central billing server for monitoring and tracking the access time and the charges associated with the services accessed by the customer through the multimedia access terminal.

14. The multimedia access terminal network of claim 13 wherein the central billing server stores and manages account data including balance amount in connection with payment through prepaid cards.

15. The multimedia access terminal network of claim 13 further comprising a remote authentication dial-in user service server connected and in operative communication between the service provider server and the central billing server for validating and providing the multimedia access terminal access to the central billing server.

16. The multimedia access terminal network of claim 12 wherein the service provider gateway server is a public switched telephone network (PSTN) gateway connected to a PSTN for providing telephone and facsimile calling service to a destination PSTN telephone device connected to the PSTN, from the multimedia access terminal through the global communications network.

17. The multimedia access terminal network of claim 12 wherein the service provider gateway server is a service provider web server connected to the global communications network for providing computer access service to a destination computer server, from the multimedia access terminal through the global communications network.

18. The multimedia access terminal network of claim 17 wherein the destination computer server is a World Wide Web (WWW)-compatible server.

19. The multimedia access terminal network of claim 16 wherein the PSTN gateway is programmed to provide telephone and facsimile calling service through a access line to an access line service provider on the PSTN.

20. The multimedia access terminal network of claim 12 wherein the multimedia access terminal comprises:
a microcontroller for executing preprogrammed instructions and generating directives;
a payment acceptor electrically connected and responsive to said microcontroller for accepting payment from the customer to pay for access to the services;
a network interface device electrically connected and responsive to the microcontroller for connecting with the remote service provider server via a global communications network; and
wherein said multimedia user interface is electrically connected and responsive to said microcontroller.
